(19) United States
(12) Patent Application Publication
(10) Pub. No.: US 2020/0059365 A1
(43) Pub. Date: Feb. 20, 2020

(54) COMMUNICATION NETWORK

(71) Applicant: WFS Technologies Limited, Livingston (GB)

(72) Inventor: Brendan Hyland, Edinburgh (GB)

(73) Assignee: WFS Technologies Limited, Livingston (GB)

(21) Appl. No.: 16/610,058

(22) PCT Filed: May 1, 2018
(86) PCT No.: PCT/EP2018/061088

§ 371 Date: Oct. 31, 2019

(30) Foreign Application Priority Data
May 1, 2017 (GB) 1706885.9
May 1, 2017 (GB) 1706887.5

(51) Int. Cl. H04L 9/32; H04L 9/06; H04B 11/00; H04B 13/02

(52) U.S. Cl. CPC H04L 9/3239; H04L 9/0637; H04L 9/3247; H04L 2209/80; H04B 11/00; H04B 13/02; H04L 2209/38; H04L 9/0643

(57) ABSTRACT

A communication network comprising a plurality of distributed nodes, each node comprising a communication module which operates to communicate wirelessly with at least one other node, and a processing module operable to act upon data communicated between at least two nodes, wherein data can be wirelessly harvested from any node using digital ledger technology to authenticate direct communication of at least some data according to a predetermined digital ledger authentication key.

The invention relates to a communication network and, in particular, to a communication network with consideration to process improvement provided with integrated monitoring and communication mechanisms.

### BACKGROUND

Subsea and underground structures, as well as those deployed in space are subject to a variety of localised factors such as pressures, currents, gravitational forces and the like which can cause wear and tear and weaken their integrity. For example, in a subsea environment, a steel catenary riser located in water depths up to 2000 m and configured in a lazy wave will, at differing depths be subjected to different currents as they occur in stratified layers within the ocean body. These different currents can also vary from movement, for example on the surface layers generated, by storm conditions. The inventors herein have recognised that a drawback with the prior art approach is that in addition to stratified layers within the ocean body, differing currents can act to generate further strain upon the subsea structure as different forces can be acting on different sections of the structure creating inter-structure strain as well as the strain of the force itself. Such wear and tear can severely limit the lifespan of a subsea structure and, with no manner in which to effectively assess the damage occurring, in order to prevent failure of the structure, the lifespan must be underestimated. Conservative estimation of the lifespan can mean replacement of a structure long before it's working life is anywhere near at its limit and therefore, when objective of a structure, such as, for example, a riser is to move hydrocarbons from seabed to topside at the lowest cost per barrel, underestimating the riser lifespan means that the capital cost per barrel for the structure is higher than necessary.

It is therefore an object of the present invention to provide a communication network which overcomes these and other issues.

### SUMMARY

According to a first aspect of the invention there is provided a communication network comprising a plurality of distributed nodes, each node comprising a communication module operates to communicate wirelessly with at least one other node, and a processing module operable to act upon data communicated between at least two nodes, wherein data can be wirelessly harvested from any node using digital ledger technology to authenticate direct communication of at least some data according to a predetermined digital ledger authentication key.

Preferable the data transmitted is processed data.

Preferably at least one node further comprises at least one sensor module operable to sense data relating to at least one predetermined criteria.

Preferably the processed data is sensed data which has been acted upon by the processor module. Alternatively, the data transmitted is performance data or communication data which has been acted upon by the processor module.

Preferably, the predetermined criteria relate to environmental information. The sensed data relating to environmental information may include sensors for conducting one or more of earthquake monitoring, meteorological ocean data monitoring or pollution monitoring.

Preferably the communication network comprises a subsea communication system.

The predetermined criteria may relate to sensed data of an underwater structure integrity including sensing data relating to one or more of fatigue, strain, acceleration, temperature and pressure.

The digital ledger technology may enable minimization of power requirement for data transmission by use of the predetermined key permission to ensure on the required data is transmitted between nodes. By using digital ledger technology in this way a network can communicate essential data wirelessly whilst minimizing power usage and therefore aiding in cost reduction and network longevity.

Nodes may be static or mobile, for example they may be deployed on a fixed asset or structure, or on the seabed. Alternatively, a node may be deployed in a moving unit, for example an AUV, ROV, diver, boat, buoy or drone.

Alternatively, the communication network may be deployed underground. Further alternatively, the communication network may be deployed in space.

Data may be transmitted wirelessly from a static node to another static node. Alternatively, data may be transmitted wirelessly from a static node to a mobile node.

Preferably each node may communicate wirelessly using at least one of acoustic, optical and electromagnetic data carrying signals.

Preferably a node may comprise a hybrid communication capability and be operable to communicate using two or more of acoustic, optical and electromagnetic data carryings signals.

Preferably, each processor module is operable to implement an analysis on sensed data. Preferably, the analysis may comprise a model correction mechanism using data measured within the network by sensor modules.

Such model analysis and correction enables an artificial intelligence approach to be implemented within the data analysis process of the network.

Conveniently, the harvesting of data can facilitate across network communication.

In a subsea network, a hybrid AUV can move across the network cross pollinating critical data and enabling transfer of large data sets across the network.

Conveniently, the AUV is operable to transfer power across the network. Conveniently the AUV can implement a battery swap with a node. Alternatively, the AUV is operable to implement a wireless recharge of the node unit.

Preferably the network includes at least one buoy unit. The buoy unit may be operable to provide local energy generation to the network. The energy generation may use one or more of solar, wind or wave power. The buoy may be hard wired to fixed nodes to provide an energy supply. Alternatively energy may be wirelessly harvested from the buoy by an AUV which may be operable to carry the energy for further transmission to a network node.

The digital ledger technology may be blockchain technology.

According to a second aspect of the invention there is provided a communication network comprising a plurality of wireless nodes distributed across a distributed structure, each wireless node comprising at least one sensor, a processor, a memory and at least one transceiver wherein the sensor is operable to measure at least one environment variable which is processed by the processor and stored in the memory prior to onward transmission by the receiver.

According to another aspect of the invention there is provided a structure monitoring and communication network having at least a structure monitoring unit comprising at least one sensor mechanism, a processor unit and a communication unit wherein the processor unit to operates to harvest data from the sensor mechanism and act upon the harvested data to generate control data which is provided to the communication unit which is operable to transmit the control data to a remote communication unit as part of the communication network.

By providing a processing unit to act on sensed unit locally to generate control data for a remote unit, real time data can be used to ensure control data is provided which enables local and remote process units to act in a manner responsive to real time circumstances.

### SUMMARY OF DRAWINGS

An embodiment of the present invention will now be described with reference to the following figures, by way of example only, in which:

FIG. 1 shows a communication network according to an embodiment of the present invention;

FIG. 2 shows a pipelogger deployed within the communication network of FIG. 1,

FIG. 3 shows a network of communication networks, and

FIG. 4 shows a communication network according to an exemplary embodiment of the present invention.

### DETAILED DESCRIPTION

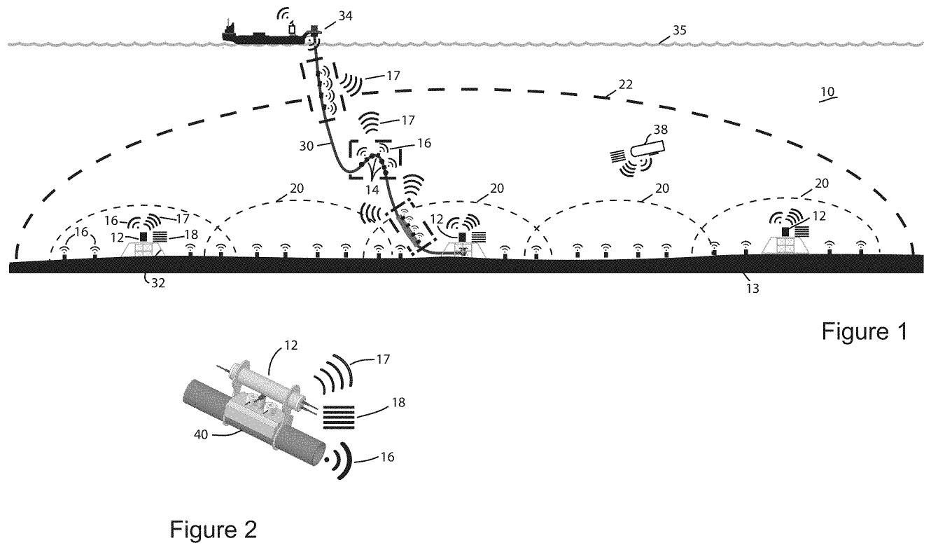

In FIG. 1 there is shown a communication network 10 comprising a plurality of sensor nodes 12 distributed across a subsea area with each sensor node, in this case, mounted upon a structure 32 fixed to the seabed 13. Each sensor node is provided with a sensor mechanism (not shown) as well as communication mechanism operable to transmit data in this case using electromagnetic communication signals 15, acoustic communication signals 17 and optical communication signals 18. Communication nodes 14 which in this case are operable to communication wirelessly using electromagnetic communication signals 16 are distributed across the seabed 13 such that a local area radio communication bubble 20 is created around each structure 32. An acoustic communication bubble 22 encompasses a plurality of sensor nodes 12.

The network 10 further includes a FSPO 34 at the ocean surface 35 which is connected to a subsea structure 32 by riser 30. The riser 30 is provided with communication nodes 14 which sit within the acoustic communication bubble 22. A further daisy chain of acoustic communication nodes 25 are provided on the riser 30 at the boundary of the acoustic communication bubble 22 to enable onward transmission of data signals from within the bubble 22 to a receiver unit such as the FSPO 34.

Within the acoustic communication bubble 22, an AUV 38, can either comprise a sensor node 12 or communication node 14 and thus be provided with a communications module operable to transmit using one or m ore of electromagnetic, optical and acoustic data carrying signals can move around harvesting data from the sensor modules 12 or communication modules 14 and carrying this data elsewhere for onward transmission. It will be appreciated that the AUV will can carry out a type of cross pollination of data carrying data from one area of the network to another area of the network as required.

It will be appreciated that the sensor modules 12 may be environmental monitoring systems enabling a subsea internet of things cloud computing network to monitor earthquakes, meteorological ocean data and pollution.

Large scale models generated by sensed data will can operate at the seabed and be subject to correction based on actual measured data. By incorporating an artificial intelligence processing mechanism into the node processors, the individual sensors and networked sensors will have an ability to implement accelerated self learning to improve prediction of issues such as earthquakes, climate change impact and pollution impact.

Data harvested from each node can be processed locally to generate only relevant data for transmission thus minimising the bandwidth requirement for onward transmission and enabling effectively local data management and control, as well as local machine learning to develop and implement more effective local control decision making. Access to the data by harvester mechanisms, or by node to node transmission can be managed using a digital ledger technology, such as blockchain or other crypto-currency type technology, which enables secure transactions and ensures that data cannot be hacked by outsiders. The digital ledger technology operates as a distributed database which enables decentralization of storage and processing of the data thus providing transparency and accountability.

Digital ledger allows for privacy of data through the combination of records and by the elimination of the need for intermediaries for data handling. Parties involved in a transfer of data can view the encrypted database and see any mutual transactions, or any transactions for which they have been given the key to see, but no one party controls the data handling process. Therefore, the AUV 38 is only able to access data from nodes 12, 14 for which it has been given access permission. Each transaction is a data set unit, or block, that is added to the digital ledger, or chain, once each mobile or static node involved in the transaction affirms the data unit, or block, is correct. The ledger itself is protected by cryptography.

Use of digital ledger technology means within the communication network means it is not possible to manipulate the system or go back and overwrite the digital ledger as it is chronologically time stamped. This means each data transfer transaction can be both authenticated and performed directly and immediately between two nodes 12, 14 in agreement. Thus, transactions offer a secure and indisputably traceable chain or events. With digital ledger, data is split and distributed in pieces all over the network system, however, only the owner of the data is able to put the data back together thus control of the data stays with the owner. Every node 12, 14 has the ability to identify which node owns the data. However, only the node with the correct key, which has been provided to the node by the data owner, can unlock access to the data. Use of digital ledger maximised both transparency and anonymity of the data transfer process as each transaction may be seen by any unit which has access to the chain but since each node has a unique alphanumeric identifier it also has the ability to decide whether to remain anonymous in the transaction between addresses. The transaction may also be programmed with algorithms which automate the transactions between nodes thus enhancing the ability of use of artificial intelligence systems to develop effective processes of using sensed real time data. It will be appreciated that the digital ledger technology implemented may be a blockchain system or some other similar crypto-currency style ledger system. It will also be appreciated that this secured chain of transactions does not have to be available to the public, indeed, it could only be visible to holders of a digital key which provides access to that specific ledger thus providing further security to the communication network. Such a secured or private digital ledger, intended only for use by a specified target audience results in a closed, and thus high security communication network system.

In some circumstances the digital ledger can be an entirely open database to which anyone may add data at any time. However, even is the communication network implements such a ledger which is open to the public, the real identity of the data contributors, or nodes or network units which are adding to the ledger will not be revealed to the public without provision of a pre-determined digital key providing such access. Such a public ledger may also contain confidential information which is only accessible to a specific node or AUV for example, whilst any node may also still be able to contribute information to the ledger without being able to gain access to the data which has been previously been stored in the ledger. To further protect the communication network, access to information in the ledger may be refused without a pre-determined key, or may only be granted upon the contributing node or reader first accepting pre-specified conditions, such as a confidentiality agreement or provision of a specific identification information in the case of an automated handshake.

The digital ledger may be implemented within the network 10 by integration of a ledger template, such as a blockchain template which can be an open source blockchain framework that enables blockchain applications to be written and to run exactly as programmed without downtime, censorship, fraud or third party interference thus facilitating peer to peer, or network to public transactions or for building a new public or private network depending on use of access control and permissions for data.

The embedded smart contracts and decentralised network provided by integration of the digital ledger technology into the network 10 enhances the Internet of Things security and consistency. Since an outage in one area of the network 10 will not impact any other area within the network when using the digital ledger technology. Thus, continual connectivity can be achieved both within the network, allowing local processing to be implemented reliably, whilst also allowing for real time communication of key data with external systems. The distributed architecture of digital ledger technology, such as blockchain, provides the network 10 with Internet of Things device identification, authentication and seamless, secure, data transfers. Digital ledger technology can also increase network security by tracing sensor data measurements to prevent duplication with malicious data.

The use of the network 10 in communication between nodes can also allow for implementation of digital twin systems. Digital twins are used widely in the oil and gas industry to provide a digital representation of an operation environment. Operating scenarios are run on the digital twin to develop a real understanding of the ramifications of the operating system. In a subsea cloud computing architecture, a precise digital twin may be deployed in a subsea cloud computing node and used as a digital template for the machine learning engine. Alternatively, a generic digital twin may be put in each subsea cloud computing node and this digital twin develops and evolves over time over data derived from that node and from other nodes within the subsea network such that the data twin is evolutionary. Then the digital twin architecture develops and evolves over time at two levels, firstly to develop the operating model itself and also to adapt over time to reflect the development of the network and the surrounding environment in which it is deployed and thus provide a new model which thus uses the outcome to develop new scenarios for real operating conditions.

In FIG. 2 there is shown a pipelogger 40 which may be an example of a sensor module 12 deployed in the network 10 which is operable to sense data in a predetermined manner, process the data locally within the pipelogger prior to onward transmission using one or more of electromagnetic, optical and acoustic data carrying signals. The pipelogger 40 may be a unit such as a Seatooth Hybrid Smart Controller which is operable to monitor movement, depth, temperature (process and seawater), process flow (ultrasonic flow), corrosion (ultrasonic thickness and cathodic protection) and water current. Data can be stored locally within a memory module contained within the pipelogger 40 and local processing, carried out by a processor contained within the pipelogger 40 can act upon large amounts of sensed data to develop critical information for onward transmission. Supervisory control and data acquisition (SCADA) in the subsea environment can use wireless communication enabled peripheral subsea sensor devices to gather data on environmental criteria and use hybrid wireless communication techniques to communicate feedback and control data across a local sensor network. Such local SCADA system processing enables real-time monitoring and local predictive model correction capabilities to facilitate artificial intelligence subsea system optimisation.

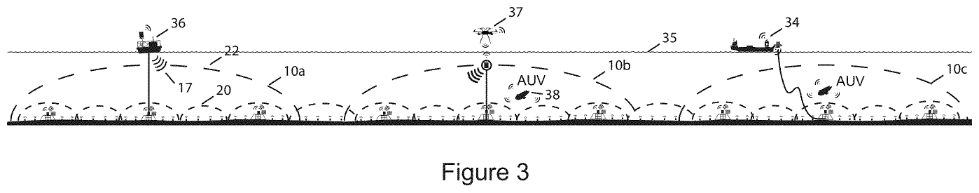

In FIG. 3 it can be seen that several communication networks 10A, 10B and 10C can be arranged adjacent one another. Arranging networks adjacently enables network extension and cross pollination of data through mobile communication units travelling from one network to another. The hybrid communication cloud structures 10A, B and C can further be interlinked with above surface cloud network communications to give optimal communication opportunities by interlinking subsea cloud computing with conventional cloud computing. The hybrid communication transmission technique can also facilitate optimised data transmission through boundary interfaces between air, water and/or through ground. By having local processing capability integrated within the network, only processed data, and not raw gathered data need be transmitted thus decreasing transmission bandwidth requirements and reducing battery usage.

For example, the hybrid communication enabled buoy 36 and/or AUV 38 are architectural elements of the system which enhance environmental applications and data harvesting of environmental data across one or multiple communication systems 10.

It will be appreciated that AUVs 38 will also can transfer energy across the network, for example by carrying out battery swaps or wireless recharge of remove sensor nodes 12 or communication nodes 14.

Buoys 36 may be sources of local energy generation when enabled with solar, wave or wind generating means. Whilst energy may be harvested and transferred wirelessly, hardwired power connections may also be implemented between the buoy and a subsea node 12, 14.

Other local energy generating techniques may be implemented within the system with power generated from sources such as thermal energy from hot process pipes, water current energy, geothermal energy and chemical energy. Furthermore, although the embodiment above relates to a subsea network, such networks and communication techniques can be implemented in underground environments or other difficult to reach environments such as in outerspace. The hybrid communication systems integrated enable through water, through ground and through air transmission of data as well as enabling transmission through interfaces between the different mediums of air/water/ground.

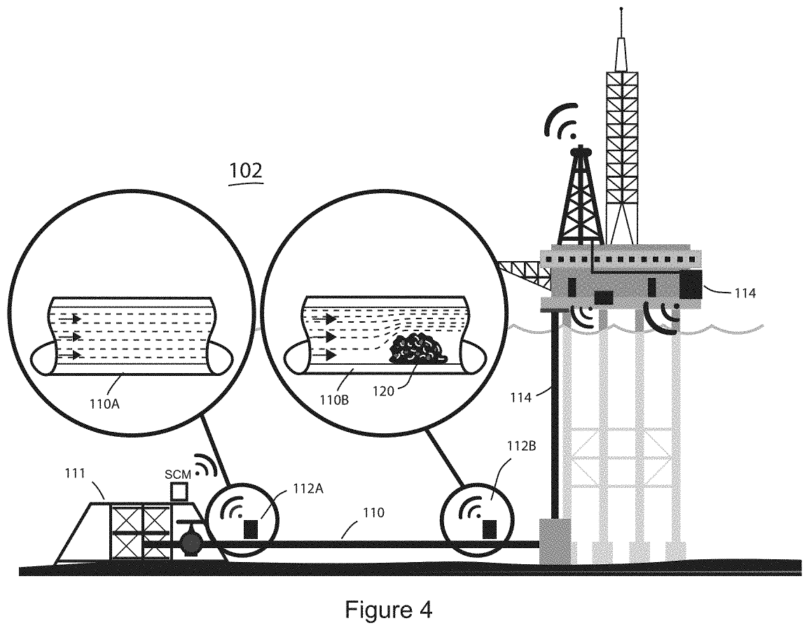

FIG. 4 shows an exemplary embodiment of the present invention implemented in a underwater system. The diagram is a block diagram of a section of a pipeline system, generally indicated using reference numeral 102, which is provided with a communication and monitoring system according to an embodiment of the present invention. The pipeline system 102 comprises a pipeline 110 leading from a wellhead 111. The wellhead is provided with a wirelessly enabled subsea control module 114. The pipeline 110 is provided with wirelessly enable monitoring nodes 112, in this case two wirelessly enabled monitoring nodes 112A, 112B are provided. The pipeline 110 leads to riser 113 which takes the hydrocarbon fluid to rig 140. The monitoring nodes 112A, B are designed to monitor flow within the pipeline 110 as well as monitoring in pipe temperature and surrounding sea temperature. The temperature of the extracted hydrocarbon fluid flowing through pipeline 110 can effect the flow of the fluid and in some cases, encourage the build up of hydrate 120 in the pipeline such as is shown in close up detail with reference to pipe section 110B. Stratified flow can occur wherein the temperature of the slower moving liquids at the bottom of a pipe can differ considerable from the gas flow above and this can have a deleterious effect upon flow by encouraging hydrate build up as well as causing problems of variable corrosion within the pipe circumference.

Using retrofittable or integrated monitoring nodes 112A,B the flow within the pipeline can be measured effectively using, for example, ultrasonic flow measuring techniques. In addition, pipelogging mechanisms can implement a measure of the temperature within the pipeline in order for a real time understanding of the flow within the pipe to be obtained.

Further to this, the monitoring nodes 112A, B are able to measure temperature of the sea surrounding the node 112A,B and thus real time sensed data of one or more of the data relating to internal pipe temperature, surrounding sea temperature and flow within the pipe can be provided to the node processor and control data based on real time environmental data can be generated.

The communications unit within the node 112A, 112B enables the control data to be wirelessly transmitted using the digital leger protocols as discussed with reference to FIGS. 1 to 3. The data transmitted from nodes 112A, B may be transmitted to the control centre which in this case is located on the rig 140 upon confirmation of the appropriate authentication key. The nodes 112A, B may be integrated within a closed loop process control system with communication units within nodes 112A, B providing control data to the wellhead control module 114 directly enabling local implementation of any required adjustments. It will be appreciated that whilst this embodiment details the network with regards to a subsea system environment, the system could similarly be in an underground environment or any other remote or difficult to access environment including in space.

The provision of two or more monitoring nodes 112A,B can enable a distributed monitoring system, in this case monitoring temperature and in-pipe flow, thus enabling identification of local real time data from sections 110A and 110B of the pipe 110. The data collected by monitoring nodes 112A, B can then be applied to control decisions across the pipeline system 102. The data recorded by modules 112A, B can be transmitted to subsea control module (SCM) 114. This distributed monitoring system means that local hot or cold spots can be identified, and their effect mitigated by the process control system embedded within the SCM 114. The model for operation of process control can be enhanced by the collection of real time data resulting in improved control of safety factor data, offline model correction and dynamic modelling. Wireless communication of the nodes 112A, B enhances the timeliness of critical information transmission and the use of digital ledger technology within the system enables rigour and transparency of data management. The SCM 114 is then able to process the received data.

The communication network herein can provide a greater understanding of integrity, for example, pipeline integrity, the structural performance is increasingly important in understanding the asset lifespan. Network apparatus enables observation, measurement, monitoring and data transmission whether the pipeline is underwater, underground or in open air. In underwater environments, deployment and retrieval of underwater vehicles to collect or obtain data can be a costly and timely process and, in circumstances where real time data is required quickly and effectively, the cost and time delay of deploying an underwater vehicle from the surface and be both too expensive and potentially too slow using traditional systems however this is overcome with the network of the present invention. Similar issues exist in underground environments or environments such as outer space where remote positioning makes physical retrieval of data difficult, timely and costly using traditional techniques. The network improves the ability of the systems to retain the privacy of data during the communication process. Looking specifically at a riser, more effective monitoring and management of a range of factors that impact the useful life of a structure, these include: fatigue due to movement (eg storms, water currents/VIV, self-induced flow movements/FIV etc), fatigue due to temperature, corrosion dur to oxidation from outside, internal corrosion due to the process, and process conditions including slugging, changes in water cut and the communication network of the present invention can monitor these in order to optimise structures and systems for maximum throughput or extended life not only for risers, but also other subsea structures such as oil platforms, offshore windmills or the like, or underground structures or structures which are deployed into the atmosphere or outerspace.

The principle advantage of the invention is that a secure wireless data transmission system can be integrated across a network in a subsea environment.

A further advantage of the invention is that communication of data across and subsea network can utilise digital ledger technology and hybrid communication systems to optimise effective data transmission and implementation of artificial intelligence in a subsea environment.

A further advantage of the present invention is the provision an improved process monitoring system utilising real time monitored data to enhance a closed control system.

A further advantage of at least one embodiment of the present invention is that a distributed monitoring system enables enhanced real time data collection.

A further advantage of at least one embodiment of the present invention is that wireless transmission of locally processed data improves responsiveness of the control system to changes in system performance and/or environmental factors.

It will be appreciated to those skilled in the art that various modifications may be made to the invention herein described without departing from the scope thereof. For example, whilst the pipeline 110 is shown as a subsea pipeline, the monitoring nodes could be applied to buried pipes, above ground pipes, across cooling spools or in other environments.

1. A communication network comprising a plurality of distributed nodes, each node comprising:
a communication module which operates to communicate wirelessly with at least one other node, and
a processing module operable to act upon data communicated between at least two nodes, wherein data can be wirelessly harvested from any node using digital ledger technology to authenticate direct communication of at least some data according to a predetermined digital ledger authentication key.

2. A communication network as claimed in claim 1 wherein the data transmitted is processed data.

3. A communication network as claimed in claim 1 wherein at least one node further comprises at least one sensor module operable to sense data relating to at least one predetermined criteria.

4. A communication network as claimed in claim 1 wherein the processed data is sensed data which has been acted upon by the processor module.

5. A communication network as claimed in claim 1 wherein the data transmitted is performance data and/or communication data which has been acted upon by the processor module.

6. A communication network as claimed in claim 3 wherein the predetermined criteria relate to environmental information.

7. A communication network as claimed in claim 1 wherein the communication network comprises a subsea communication system.

8. A communication network as claimed in claim 3 wherein the predetermined criteria relates to sensed data of an underwater structure integrity including sensing data relating to at least one of fatigue, strain, acceleration, temperature and pressure.

9. A communication network as claimed in claim 1 wherein the digital ledger technology enables minimization of power requirement for data transmission by use of the predetermined key permission to ensure on the required data is transmitted between nodes.

10. A communication network as claimed in claim 1 wherein the communication network is deployed underwater.

11. A communication network as claimed in claim 1 wherein the communication network is deployed underground.

12. A communication network as claimed in claim 1 wherein the communication network is deployed in space.

13. A communication network as claimed in claim 1 wherein data is transmitted wirelessly from a static node to another static node.

14. A communication network as claimed in claim 1 wherein data is transmitted wirelessly from a static node to a mobile node.

15. A communication network as claimed in claim 1 wherein each node is operable to communicate wirelessly using at least one of acoustic, optical and electromagnetic data carrying signals.

16. A communication network as claimed in claim 1 wherein each node comprises a hybrid communication capability and be operable to communicate using two or more of acoustic, optical and electromagnetic data carryings signals.

17. A communication network as claimed in claim 1 wherein each processor module is operable to implement an analysis on sensed data.

18. A communication network as claimed in claim 1 wherein the analysis comprises a model correction mechanism using data measured within the network by sensor modules.

19. A communication network as claimed in claim 1 wherein the digital ledger technology is blockchain technology.

20. A communication network comprising a plurality of wireless nodes distributed across a distributed structure, each wireless node comprising at least one sensor, a processor, a memory and at least one transceiver wherein the sensor is operable to measure at least one environment variable which is processed by the processor and stored in the memory prior to onward transmission by the receiver.

21. A structure monitoring and communication network having at least a structure monitoring unit comprising at least one sensor mechanism, a processor unit and a communication unit wherein the processor unit to operates to harvest data from the sensor mechanism and act upon the harvested data to generate control data which is provided to the communication unit which is operable to transmit the control data to a remote communication unit as part of the communication network.
